(19) United States
(12) Patent Application Publication
(10) Pub. No.: US 2016/0154140 A1
(43) Pub. Date: Jun. 2, 2016

(54) System and Method for Aerial Surveying or Mapping of Radioactive Deposits

(71) Applicants: Fission 3.0 Corporation, Kelowna (CA); Special Projects Incorporated, Calgary (CA)

(72) Inventors: Kaj Eston Hedin, Calgary (CA); Curtis Michael Zaiss, Calgary (CA)

(21) Appl. No.: 14/905,237

(22) PCT Filed: Jul. 15, 2014
(86) PCT No.: PCT/CA2014/050672

§ 371 Date: Jan. 14, 2016

Related U.S. Application Data
(60) Provisional application No. 61/846,543, filed on Jul. 15, 2013.

(51) Int. Cl. G01V 5/02

(52) U.S. Cl. CPC G01V 5/025

(57) ABSTRACT

A method for aerially surveying a geographic area for any surface or subterranean radioactive geological deposits using an aircraft having at least one radiation detector element comprises: a) flying the aircraft over the geographic area to be surveyed at a ground speed of between 30 and 60 m/s and at a flight height of between 10 and 20 m above ground level; b) acquiring a series of radiation signal data using at least one radiation detector element while flying the aircraft over at least a portion of the geographic area; and c) storing the series of acquired radiation signal data. A system for conducting the method is also provided.

### CROSS REFERENCE TO PRIOR APPLICATIONS

The present application claims priority under the Paris Convention to U.S. Application No. 61/846,543, filed Jul. 15, 2013, the entire contents of which are incorporated herein by reference.

### FIELD OF THE INVENTION

The present invention relates generally to geological survey systems and methods. In particular, the invention relates to an airborne system and method for surveying a geographic area and detecting and/or mapping the locations of radioactive geological deposits, such as boulders and clusters of rock. In one aspect, the invention has use in detecting uranium deposits.

### BACKGROUND OF THE INVENTION

Currently, airborne prospecting for radioactive minerals is carried out by flying a fixed wing aircraft equipped with large detectors having volumes of between 32 and 48 liters at an altitude of between 80 and 150 m and at a speed of more than 220 km/hr over a geographical region to be surveyed. However, data collected in such a manner often does not allow for detection of localized geological deposits such as boulders and clusters of rock due to the large footprint of the measurement and the resulting background-to-signal ratio (or signal to noise ratio).

Surveying methods using helicopters provide better ability to follow terrain in hilly and mountainous areas but are limited by performance and safety concerns to conduct flight at the height above ground required to detect localized geological deposits such as boulders and clusters of rock following the manner in which the aircraft is operated. Helicopters are capable of slow flight but safety concerns and operating range restriction generally limit the use of helicopters to local surveys. Generally, in mining applications, helicopters are used only when fixed wing operations are precluded due to steep terrain or in the case where a combination of other sensors is required to be towed on a long-line below and away from the aircraft.

Legacy survey systems, although utilizing large detector systems typically consisting of 16 and 32 liter detector volumes, lacked the electronic navigation and data acquisition tools required to collect and compile airborne data in a manner required to detect boulders and clusters of rock.

Various survey methods and systems are known in the art. Some of these known methods and systems are disclosed in the following U.S. Pat. Nos. 5,214,281; 5,371,358; 5,585,628; 6,727,505; and, 7,365,544.

There exists a need for an improved airborne survey system and method that results in a more accurate means of uncovering desired geological deposits, in particular deposits containing radioactive materials. Such radioactive material includes uranium.

### SUMMARY OF THE INVENTION

In one aspect, there is provided a method and system for conducting an aerial survey of an area for subterranean radioactive deposits. The system comprises one or more radiation detector elements provided on an aircraft, preferably a fixed wing airplane. The system may include data gathering, storing and processing equipment as well as related software.

In one aspect, there is provided a method for aerially surveying a geographic area for surface or subterranean radioactive geological deposits using an aircraft having at least one radiation detector element, the method comprising the steps of:

a) flying the aircraft over the geographic area to be surveyed at a ground speed of between 30 and 60 m/s and at a flight height of between 10 and 20 m above ground level; and,

b) acquiring a series of radiation signal data using the at least one radiation detector element.

In another aspect, the method further comprises the steps of

a) identifying data points in the series of radiation signal data with total counts greater than a threshold total counts, and with at least one of the element counts greater than a corresponding threshold element count;

b) flagging the data points identified in step a) as “high priority” points;

c) identifying data points in the series of radiation signal data with total counts greater than the threshold total counts, and with none of the element counts greater than the corresponding threshold element counts;

d) identifying data points in the series of radiation signal data with total counts less than or equal to the threshold total counts, and with at least one of the element counts greater than the corresponding threshold element counts;

e) flagging any data points identified in steps c) or d) as “low priority” points; and,

f) mapping geographical coordinates corresponding to the “high priority” data points using a first marker and mapping geographical coordinates corresponding to the “low priority” data points using a second marker.

In another aspect, there is provided a method for processing and mapping a series of radiation signal data acquired by aerially surveying a geographic area for any surface or subterranean radioactive geological deposits using an aircraft having at least one radiation detector element, the method comprising the steps of:

a) identifying data points in the series of radiation signal data with total counts greater than a threshold total counts, and with at least one of the element counts greater than a corresponding threshold element count;

b) flagging the data points identified in step a) as “high priority” points;

c) identifying data points in the series of radiation signal data with total counts greater than the threshold total counts, and with none of the element counts greater than the corresponding threshold element counts;

d) identifying data points in the series of radiation signal data with total counts less than or equal to the threshold total counts, and with at least one of the element counts greater than the corresponding threshold element counts;

e) flagging any data points identified in steps c) or d) as “low priority” points; and,

f) mapping geographical coordinates corresponding to the “high priority” data points using a first marker and mapping geographical coordinates corresponding to the “low priority” data points using a second marker.

In another aspect, there is provided a system for aerially surveying a geographic area for surface or subterranean radioactive geological deposits, the system comprising:

a) an aircraft adapted to fly over the geographic area to be surveyed at a ground speed of between 30 and 60 m/s and at a flight height of between 10 and 20 m above ground level; and,

b) at least one radiation detector element adapted to acquire a series of radiation signal data.

In another aspect, the system further comprises at least one processor comprising one or more tangible computer readable storage media having stored thereon a data processing module for:

a) identifying data points in the series of radiation signal data with total counts greater than a threshold total counts, and with at least one of the element counts greater than a corresponding threshold element count;

b) flagging the data points identified in step a) as “high priority” points;

c) identifying data points in the series of radiation signal data with total counts greater than the threshold total counts, and with none of the element counts greater than the corresponding threshold element counts;

d) identifying data points in the series of radiation signal data with total counts less than or equal to the threshold total counts, and with at least one of the element counts greater than the corresponding threshold element counts;

e) flagging any data points identified in steps c) or d) as “low priority” points; and,

f) mapping geographical coordinates corresponding to the “high priority” data points using a first marker and mapping geographical coordinates corresponding to the “low priority” data points using a second marker.

### BRIEF DESCRIPTION OF THE DRAWINGS

These and other features of the invention will become more apparent in the following detailed description in which reference is made to the appended drawings wherein:

FIG. 1 is a simulated response profile of counts detected at various flight heights for a surface target.

FIG. 2 is a simulated response profile of counts detected at various flight heights for a target buried under 1 cm of soil.

FIG. 3 is a simulated response profile of counts detected at various flight heights for a target buried under 10 cm of soil.

FIG. 4 is a simulated response profile of counts detected at various flight heights for a target buried under 10 cm of soil taking into account the background noise.

FIG. 5A is a simulated response profile of counts detected at various flight heights for a target buried under 1 cm of soil with sample rate of 1 Hz.

FIG. 5B is a simulated response profile of counts detected at various flight heights for a target buried under 1 cm of soil with sample rate of 5 Hz.

FIG. 6A is a simulated response profile of counts detected at various flight heights for a target buried under 10 cm of soil with sample rate of 1 Hz.

FIG. 6B is a simulated response profile of counts detected at various flight heights for a target buried under 10 cm of soil with sample rate of 5 Hz.

FIG. 7A is a simulated response profile of counts detected at various flight heights for a target buried under 10 cm of soil with sample rate of 1 Hz taking into account the background noise.

FIG. 7B is a simulated response profile of counts detected at various flight heights for a target buried under 10 cm of soil with sample rate of 5 Hz taking into account the background noise.

FIG. 8 is a flow diagram illustrating a method for processing a series of radiation data to identify and map the geographical locations of geological deposits in accordance with one embodiment.

FIG. 9 is a table showing the acquired radiation data in one embodiment.

FIG. 10 is a map showing the geographical locations of the “high priority” points and “low priority” points in one embodiment.

### DETAILED DESCRIPTION OF THE INVENTION

In order to detect, identify and/or locate localized surface and subterranean radioactive geological deposits using an airborne system, the following must occur: radiation emanating from a deposit body, or target, (e.g. boulders or rock clusters) must travel through the body and any obstructions including the ground, vegetation and air; the radiation must avoid being captured by the obstructions, as each obstruction increases the probability that the radiation, typically in form of gamma rays, will be captured and not continue; the radiation, when it eventually reaches an aircraft equipped with at least one radiation detector, must be captured fully by the detector to measure the magnitude of the event that caused the radiation to be emitted. In a preferred embodiment, the radiation detector comprises a scintillator, which emits light when struck by ionizing radiation (e.g. gamma radiation) and a light sensor such as a photomultiplier or photodiode for sensing when and how much light is emitted by the scintillator. In such embodiment, the scintillator must be sufficiently large to fully capture the ionizing radiation, since without sufficient thickness, the radiation would not be fully captured and the magnitude of the event cannot be measured. Upon the radiation being captured by the scintillator, the number of photons emitted by the scintillator as the result of the capture is counted by the light sensor. The collection of counts is then integrated to produce a spectrum at regular intervals.

In one aspect of the present invention, the data acquisition system that samples the photomultiplier outputs operates at very high rates, such as for example 80 MHz. In this way, the system and method of the invention can effectively capture every radiation causing event and produce any output integrated sample rate.

In one aspect of the present invention, the collection of counts is integrated at least once every second (i.e. at a sampling rate greater than 1 Hz). This can be referred to as the post-processed integrated sample rate. In a preferred embodiment, the collection of counts is integrated at least five times every second (i.e. at a sampling rate of 5 Hz or greater). Once the desired spectrum is produced, at least one window or range within the spectrum is chosen for monitoring purposes, which correspond to the radiation energy of at least one of the three naturally occurring radioelements of interest: potassium-40 (K⁴⁰), uranium-238 (U²³⁸) and thorium-232 (Th²³²). In a preferred embodiment, the windows or ranges corresponding to all three radioelements of interest are monitored. In a preferred embodiment, a stripping procedure is used to remove a prescribed number of counts from at least some of the windows or ranges being monitored to eliminate any known overlapping counts between windows. The resulting output is an estimate of the radiation concentration at ground level for each radioelement.

One difficulty that arises in detecting localized geological deposits such as boulders and clusters of rock is that these deposits only represent a small portion of the counts detected by the system. One way to mitigate this problem is to reduce the overall area of survey, thereby increasing the percentage of total counts attributed to the deposits. This may be achieved in two ways. The first is by assembling the detectors in an array, such that some detectors are positioned in a center location and are effectively blocked by the surrounding detectors from detecting radiation travelling towards the detectors at sharp angles. This configuration results in the center detectors only detecting radiation emanating from a smaller effective area. In a preferred embodiment, the detectors are configured in a 4×4 array, thus enabling the 12 outer detectors to block the radiation incoming at a sharp angle from reaching the 4 center detectors. Additionally, coincidence and anticoincidence counters may be used to reduce the number of counts that result from radiation that did not pass directly through the bottom of the detector or radiation that was not fully captured by the scintillator. The second way of decreasing the survey area is by changing the flight altitude, since the area being surveyed naturally decreases as the altitude of the aircraft decreases. It is estimated that the diameter of a survey area is approximately four times the altitude.

Another difficulty that arises in detecting localized geological deposits is the spatial resolution of the detection system. As is well known in the field, spatial resolution is affected by a number of factors such as the area of land being surveyed and the presence of obstacles that the radiation must penetrate to reach the detectors. These obstacles include, for example, dirt, rock, vegetation, water, snow and air. As illustrated below, as radiation travels though these obstacles, it becomes attenuated, thus resulting in lower counts upon passing through the obstacles. Furthermore, as will become apparent, the longer the distance that the radiation must travel through these obstacles to reach the detectors, the more attenuated the signal becomes. As a result, in general, spatial resolution of data acquired at relatively high altitudes is poor. In particular, radiation from distant sources can be picked up because air is a poor attenuator and because at high altitudes the distance the gamma rays must travel through the dirt/water/snow is reduced. However, at lower altitudes, it has been found possible to exploit this attenuation effect to increase the spatial resolution of the detection system by balancing the benefits of this effect with its limitations.

The attenuation of radiation through a medium is governed by a simple exponential equation as shown below:

$${C}_{out} = {C}_{in} {e}^{( - \frac{d}{TVL} )}$$

wherein Cₒᵤₜ represents the counts exiting the medium, Cᵢₙ represents the counts entering the medium, d is the thickness and TVL is the “Tenth Value Layer Thickness”, which is the thickness at which 90% of the counts are attenuated. For example, it is well known that the TVL value of air is approximately 340 m whereas that of water is approximately 18 cm. However, as will be understood by persons skilled in the art, a TVL value is a function of the density of the material, the molecular structure of the material and the energy of the gamma rays or X-rays passing through the material.

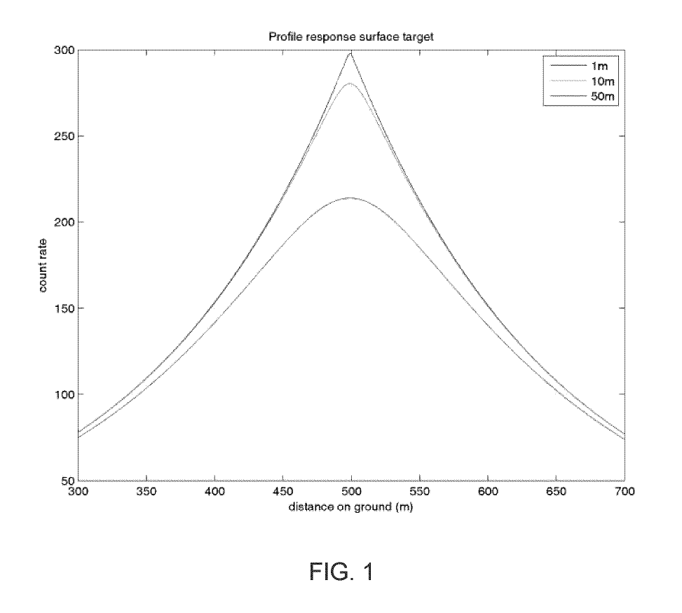

Based on the above equation, computer simulations were carried out to determine the profile of the counts for a surface target as well as for subterranean targets buried at 1 cm and 10 cm. Each simulation was carried out for detector heights of 1 m, 10 m and 50 m, and results of these simulations are shown in FIGS. 1 to 4. It is also noted that, for simplicity, these simulations were carried out to simulate the profiles detected in scenarios where a detector with infinite volume and infinite sample rate is used for detection. This scenario would be practically achievable with a finite volume system if the detector is either not moving or moving very slowly.

As shown in FIG. 1, the surface target is strongly detected at a horizontal distance of more than 200 meters away from the source at any height. However, it should be noted that surface targets rarely exist except in extremely barren environment and only if the target is sitting above the ground and not embedded in it. This is generally not the case, as various obstructions and terrain variations block the path of radiation to the detector. Additionally, if surface targets are encountered, the spatial resolution would greatly suffer as counts from multiple surface targets spaced less than 200 meters apart would add up to produce a profile indicative of a surface target location somewhere between the actual target locations. This type of effect is, however, observed with the background and surface radiation.

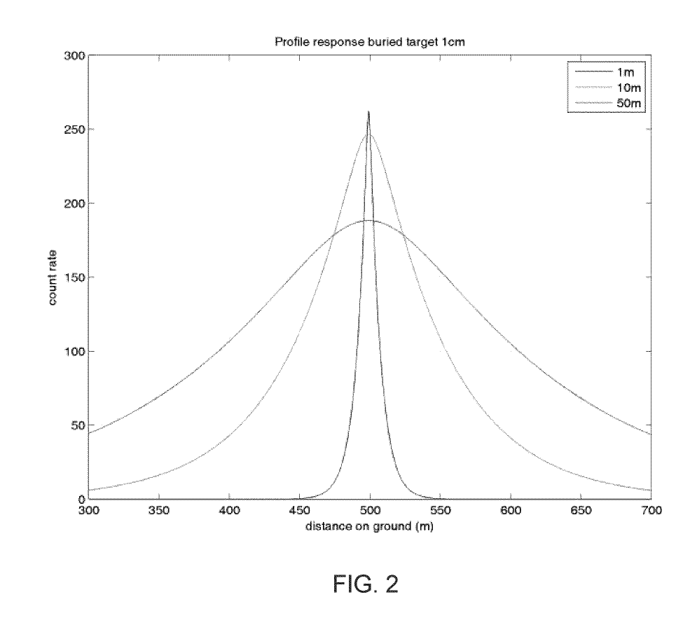

FIG. 2 shows the simulated profile when the target is buried 1 cm below the surface in soil, and it clearly shows the effects of the ground attenuation at lower heights. Based on this simulation, a person walking on the ground with a detector could detect the target from a horizontal distance of approximately 25 m from the target. As can be seen from the simulated profiles, the peak is relatively narrow when the detector is at a height of 1 m, but it quickly broadens as the detector height above ground is increased. This is due to the fact that at lower heights, the radiation emanating from the target must travel at a shallow angle relative to the ground through soil to reach a detector that is horizontally spaced apart from the target. The long distance that the radiation must travel through soil results in strong attenuation and thus low counts. However, when the detector is brought closer to the target while maintaining the same height, the distance that the radiation must travel through soil quickly decreases due to the change in the angle of path between the target and the detector, thus decreasing the degree of attenuation and giving rise to higher counts. This effect is less pronounced at higher heights due to the fact that changes in the angle of path between the target and the detector from horizontal detector movement is not as significant compared to low height scenarios. Having said so, the problem still exists that counts detected from multiple targets could combine to mask the locations of individual targets.

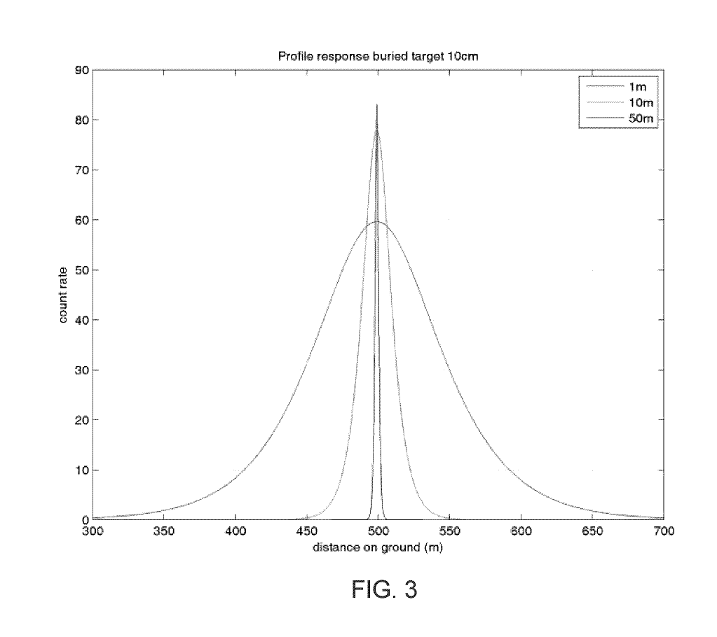

FIG. 3 shows the simulated profile when the target is buried under 10 cm of soil. At this depth, the profile is significantly narrower than in FIG. 2. A person walking on the ground with a detector at a height of 1 meter would need to be within a few meters of the target in order to detect it, whereas a plane flying at 10 meters would be able to detect it at approximately 25 meters away from the target.

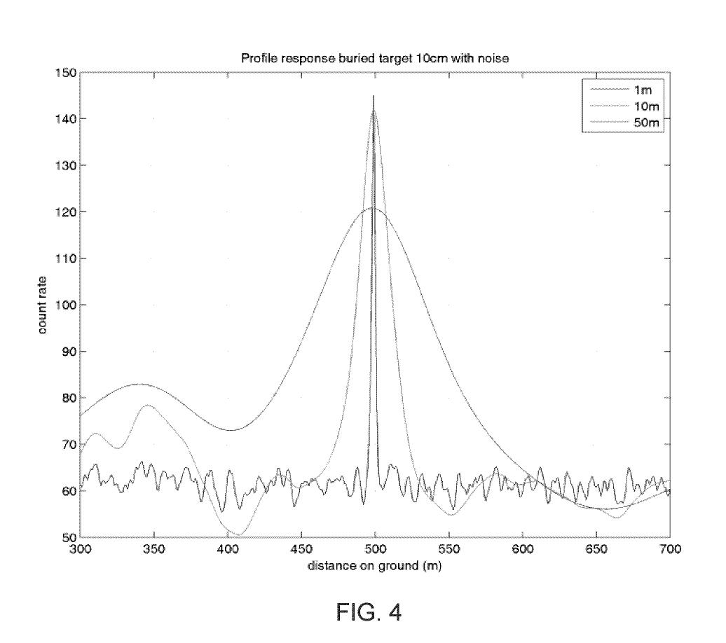

FIG. 4 shows the simulated profile when background noise is added to the simulation. Here, the target is easily identifiable when the detector is just 1 meter above ground; however, at higher heights, many small anomalies add up to create false peaks which make it difficult to identify the actual location of the target. This effect is particularly pronounced in the scenario where the detector is flown at a height of 50 meters above ground.

Based on the simulation results shown in FIGS. 1 to 4, it would appear that the best spatial resolution is attained when the detector is flown at a height of 1 meter. However, a typical aircraft does not have an infinite volume system, nor can it remain stationary over a particular location. Also, by flying at a height of 1 meter, the coverage is reduced to only a few meters, so the production rate would be very slow for a large area, as line spacing would have to be decreased significantly.

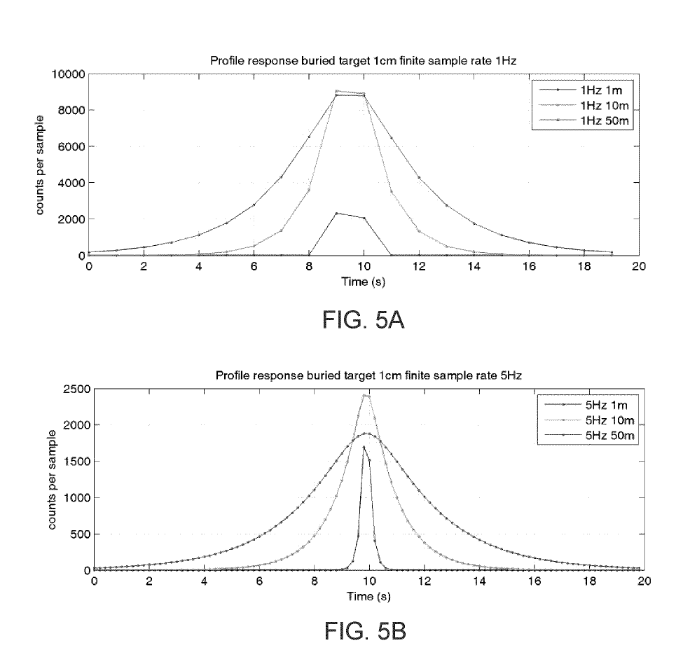

A more accurate simulated profile response can be obtained by taking into account “real-world” factors such as a finite volume, a velocity and data sampling rate into the simulation. The results of those simulations are shown in FIGS. 5A-7B.

FIGS. 5A and 5B show the simulated true responses of the system as it would be measured and sampled at two sample rates: 1 Hz and 5 Hz. A 1 Hz sample rate is commonly used by most systems as it provides a good balance between counts and spatial resolution. However, this sample rate becomes less suitable when time on target (i.e. the amount of time that the detector is positioned over the target) is reduced or when a ground attenuation effect is present.

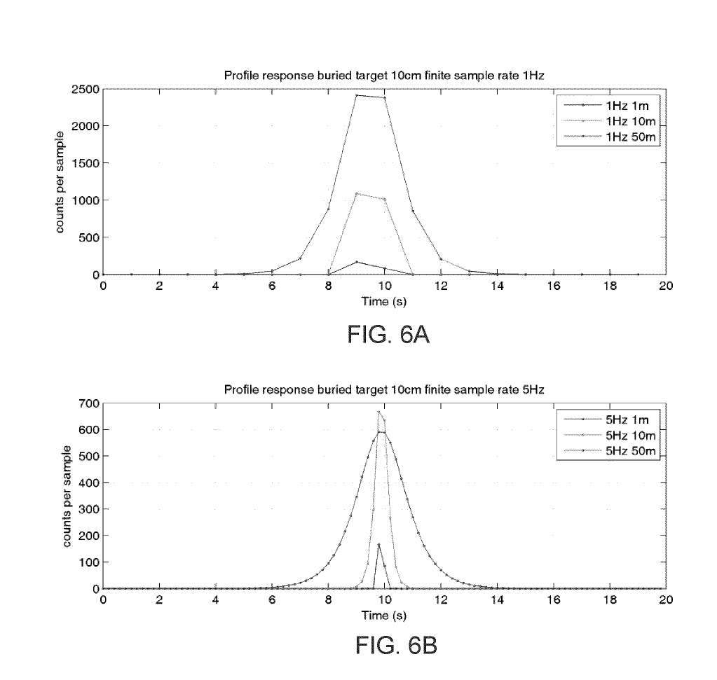

FIGS. 6A and 6B show the simulated true responses of the system for a target buried at a depth of 10 cm. As shown in FIG. 6A, the 1 Hz sample rate is insufficient for clearly identifying the location of the target due to an error of up to 1 second which, at a ground speed of 50 m/s, could result in an error of up to 50 meters. On the other hand, as shown in FIG. 6B, the location of the target can be identified with only a small error margin of approximately 10 meters at any of the heights when the 5 Hz sample rate is used.

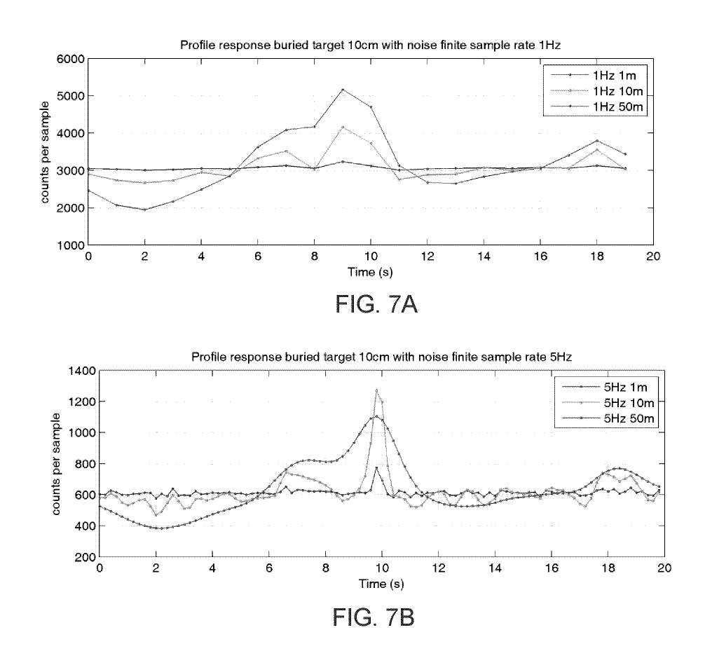

FIGS. 7A and 7 B show the simulated true responses of a buried target when a low level background radiation is taken into account. In the simulation result shown in FIG. 7A, the effect of noise integration at higher heights creates false peaks, which, when sampled at 1 Hz, appears similar to the true peak. In FIGS. 7A and 7B, the false peaks, when compared to the 1 m altitude (which is the best representation of true), are noted at times of 7 and 18 seconds. The 1 Hz sample rate also reduces the peak height produced by the target at the height of 1 meter to a point where it is virtually indistinguishable from the background. However, as shown in FIG. 7B, the data acquired using the 5 Hz sampling rate is an improvement as the false peak and the true peak are distinguishable at least at low heights. There is, however, a significant loss of detectable counts when the detector is flown too low. This is because the time over target is dramatically reduced at low heights to such a degree that counts from the target are barely distinguishable at the 1 meter level, as shown in FIG. 7B.

Based on the above analysis and supporting test data, the optimal range of flight and acquisition parameters were determined. In an embodiment, the optimal flight height was determined to be between 10 and 20 meters above ground level and the optimal ground speed or flight speed was determined to be between 30 and 60 m/s. In a preferred embodiment, the optimal flight height was determined to be between 10 and 15 meters above ground level. Also in a preferred embodiment, optimal ground speed or flight speed was determined to be between 45 and 55 m/s. For detector acquisition parameters, in a preferred embodiment, the optimal sample rate for one or more detector was determined be 5 Hz. The 5 Hz sampling rate is particularly applicable in an embodiment where a 4×4 array of 16 one liter NaI(Ti) (thallium-doped sodium iodide) detectors are used for surveying. Such detectors use NaI crystals for scintillation counting. As known in the art, Nal crystals emit light when exposed to gamma radiation, with the amount or intensity of the emitted light being proportional to the amount gamma radiation energy deposited in the crystal. Although a larger detector array, and a faster sample rate, may be used when flying at lower altitudes, a larger aircraft would be required to carry the larger array, and such aircrafts are typically not capable of flying at such low altitudes. Alternatively, the aircraft may be flown slower with reduced sample rate to obtain substantially the same results over a longer time period.

There are also a number of system designs and data processing methods which may be used to improve the quality of data, as well as for identifying and mapping the locations of radioactive geological deposits.

As previously mentioned, in one embodiment, relatively small cubic detectors, approximately 1 L in size, are used in the invention to improve the spectral resolution, thus maximizing the use of limited counts. There are two main advantages to using such detectors. Firstly the distance of material the light pulse inside the detector must travel through causes the magnitude to decay. Thus, the larger/longer the detector the larger the difference between the near and far pulses. Secondly, the small volume of the detector results in only a minor pulse accumulation, or “pulse pileup”, thus reducing the likelihood of multiple signals being overlapped.

In addition, various calibration methods may be used both before collecting the data and after the data has been collected (i.e. during the post-processing stage) to improve the accuracy of the acquired data.

In one embodiment, the detectors are calibrated for magnetic variation and thermal sensitivity. This is particularly useful in improving the spectral stability of small detectors as it maximizes the use of limited counts and calibration on potassium counts is generally not very accurate due to lower count rate. In a preferred embodiment, the accuracy of the thermal calibration is improved by estimating the core temperature of the crystal in the detector based on the initial temperature of the crystal, the surface temperature of the detector (in lieu of the internal temperature of the crystal, as discussed further below) and known thermal properties of the crystal. In particular, according to one embodiment, the core temperature of the crystal is estimated as a function of the previous crystal temperature and the surface temperature of the detector based on an empirical thermal model of the crystal. In one example, the initial temperature of the crystal is determined by assuming that the initial crystal temperature is equal to the surface temperature of the detector, as an approximation of a fully stabilized system. In another example, the initial temperature of the crystal is determined based on the gain measured during calibration by using a static source calibration and a known gain temperature model. By using such calibration methods, the possible difference between the temperature measured at the surface, or outside of, the detector and the actual temperature at the crystal core where the radiation is captured is reduced.

In one embodiment, all raw count data is saved to reduce the time spent performing extensive equipment calibrations. Saving the raw count data enables the recalibration of all the spectrums during post-processing. As a result, there is no need to perform extensive daily calibration checks of the detection system. It has also been found that, for most cases, proper temperature and magnetic compensation almost completely accounts for drift in the sensors.

In a preferred embodiment, the ground speed of the aircraft is maintained at a constant value with a variation of less than 10%, since the velocity of the aircraft determines the time over target and thus the total number counts obtained from the target. Furthermore, there is no practical way to account for variations in the aircraft velocity during post processing without knowing the true response. Also in a preferred embodiment, the altitude of the aircraft is maintained at a relatively constant level since there are no practical methods for correcting the data to account for variations in altitude. Ideally, according to one aspect of the invention, the altitude of the aircraft is maintained between approximately 10 and 15 m. However, the actual altitude must take into consideration the heights of trees. As such, in areas where trees are higher than the desired altitude of 10-15 m, the aircraft is maintained at an altitude of approximately 10 m, or any other set distance, above the tree height.

In an aspect of the invention, it may be necessary to survey a relatively large geographic area. In such scenarios, an aircraft equipped with at least one detector is commonly flown over a portion of the area to be surveyed to acquire data from a small strip of land that falls within the entire geographic area to be surveyed. Once the aircraft reaches the end of the strip, the heading of the aircraft is reversed and the position of the aircraft is offset, such that a neighboring strip of land adjacent to the previously surveyed strip is then surveyed. The aircraft continues to survey the land in this manner until the entire geographic area has been surveyed. Generally, the line width, or the distance by which the aircraft is offset each time a strip of land has been surveyed, should be no more than the width of the strip of land. In one embodiment, the line width is between 40 and 80 meters. In a preferred embodiment, the line width is between 40 and 60 meters. In one aspect of the invention, the line spacing is related to the area of investigation, which in turn is related to the altitude at which the measurements are taken. For example, in a first survey the line width may be 50 m, and for subsequent or follow-up surveys, the line width may be reduced to, for example 25 m, so as to overlap readings so as to verify potential targets.

In a preferred embodiment, a fixed-wing aircraft is operated at an altitude of between 10 and 15 meters above the ground and at a ground speed of 50 m/s while carrying an array of radiation detectors to survey a geographic area. In a further preferred embodiment, a tight terrain drape flight with a flight line spacing of 50 meters is used to obtain high speed digitizing and sampling of the data from an array of radiation detectors and several other sources of complimentary data. In a preferred aspect of the invention, the detectors are sampled at a sampling rate of 80 Mhz, with the post-processed integrated sample rate being 5 Hz.

In traditional methods of surveying, the aircraft must be flown only during dry summer days to limit the amount of precipitation on the ground and humidity in the air, as these factors cause significant changes to the degree of attenuation from day to day. However, in the present method of surveying, these restrictions do not generally apply, as humidity in the air has negligible effect on the signal due to the low flight altitude. Additionally, in certain circumstances, the attenuation due to moisture in the soil or presence of snow may actually be beneficial to the detection of localized geological deposits as these improve the spatial resolution of the acquired data as described previously. In one example, a geographic region was surveyed in the summer and again in the winter when there was approximately 1 meter of snow on the ground. When the data acquired in the winter was compared to the data acquired from the same geographic region in the summer, approximately a 25% improvement in the peak-to-background ratio was observed owing to the increased attenuation due to the snow, which improves the spatial resolution of the signal.

The method of the invention also provides for identifying and mapping “hot spots”, or anomalies in data which generally indicate the location of one or more radioactive geological deposits, such as boulders and clusters of rock.

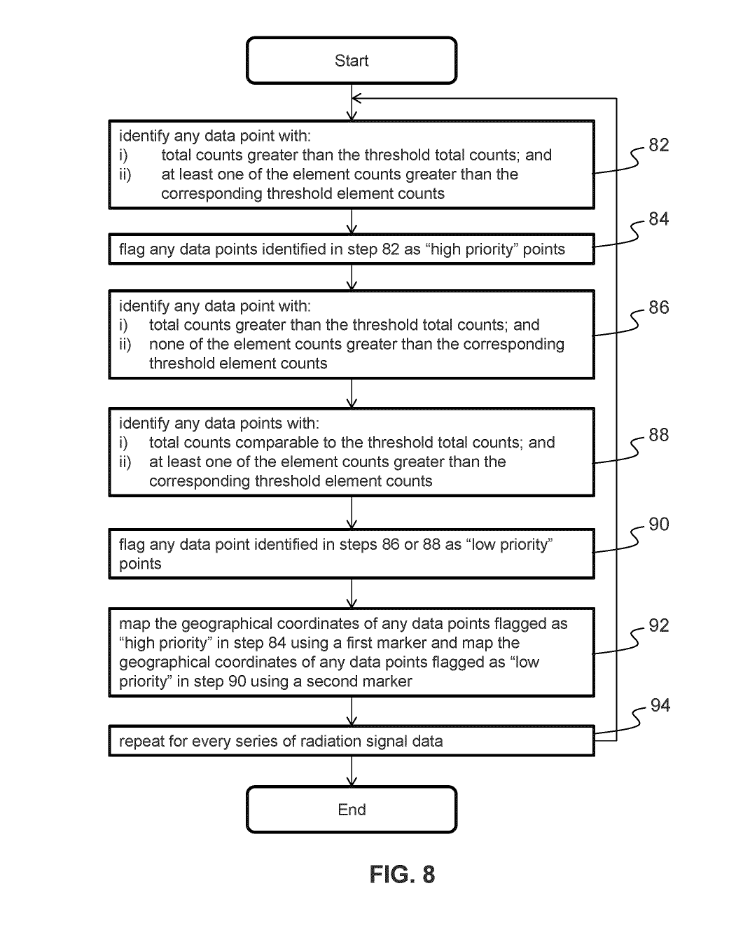

FIG. 8 illustrates a flow diagram of a method for processing and mapping a series of radiation signal data which have been acquired by aerially surveying a geographic area for any surface or subterranean radioactive geological deposits using an aircraft with at least one radiation detector element according to a preferred embodiment. In a preferred embodiment, the data is structured such that the series of radiation signal data contains the entire radiation signal data acquired over a portion of the flight path. For example, the series of radiation signal data may contain all of the radiation data acquired from surveying a small strip of land that fall within the entire geographic area to be surveyed. As such, in an embodiment where two or more strips of land were surveyed to encompass a large geographic area, the radiation data collected from surveying each strip of land may be stored as separate series of radiation signal data. Furthermore, in a preferred embodiment, each data point in the series of radiation signal data is associated with location data, such as, for example, the coordinates of the geographic location where the data point was acquired or a time stamp, which may be correlated with flight records to identify the geographic location where the data point was acquired.

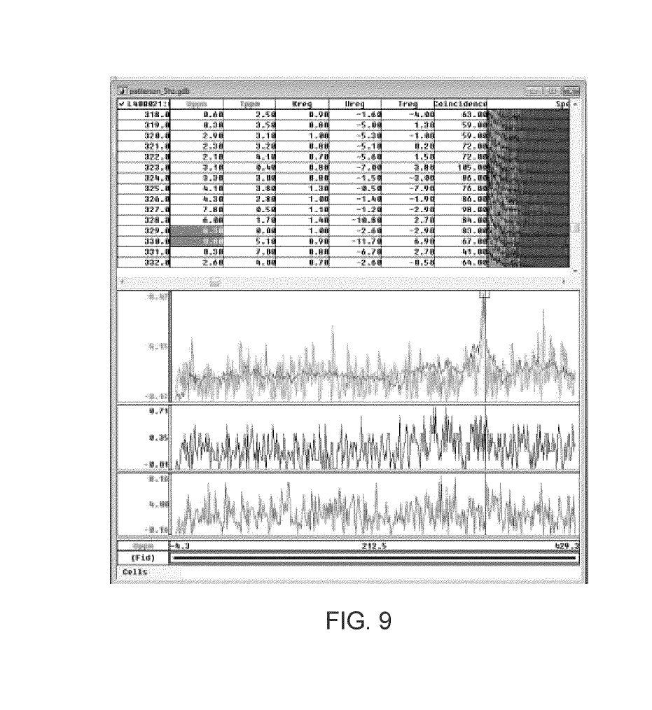

In one embodiment, each data point further includes measurements such as calibrated counts attributed to each radioactive element, equivalent ground concentrations of each radioactive element in ppm (e.g. Uₚₚₘ, Kₚₚₘ, Thₚₚₘ) which may be calculated using known sensitivity coefficients of the system, percentages of each radioactive element (e.g. K %) and total counts, which is a sum of the calibrated counts of each radioactive element. In one aspect, the total counts is the sum of the entire spectrum, i.e. it is calculated by adding together the counts from each radioactive element detected by all of the detectors. However, depending upon the survey terrain and the number of counts, total counts may be calculated by adding together counts from only some of the detectors. For example, given that a sufficient number of counts has been detected, separate total counts may be calculated for center detectors and peripheral detectors, thus enabling the operator to estimate at least the direction of the radiation source relative to the position of the detectors. Similarly, separate total counts may be calculated for detectors on the left side and detectors on the right side of the aircraft, etc. An example of a table showing a plurality of series of radiation signal data is shown in FIG. 9. It will also be appreciated that various calibrations and post-processing steps may be taken prior to or after processing the data. These may include, but are not limited to: background correction, stripping correction, height correction and sensitivity correction.

Returning to FIG. 8, at step 82, any data points in the series of radiation signal data with total counts greater than the threshold total counts and at least one of the element counts greater than the corresponding threshold element counts are identified. In one embodiment, the threshold total counts is the background level of total counts. In a preferred embodiment, the threshold total counts is one standard deviation above the background total counts. Similarly, in one embodiment, the threshold element counts is the background element counts for each element. In a preferred embodiment, the threshold element counts is one standard deviation above the background element counts for each element. However, it will be appreciated that other threshold total counts and threshold element counts may be used instead, such as, for example, two or three standard deviations above the corresponding background counts.

Once these data points have been identified, they are flagged as being “high priority” points (i.e. “hot spots”) at step 84. As it will be appreciated by a person skilled in the art, the identified data points may be flagged in any number of ways. This may be done, for example, by assigning a numerical value which corresponds to the priority level of the data points, or by highlighting the data points in a spreadsheet.

In step 86, any data points in the series of radiation signal data with total counts greater than the threshold total counts and none of the element counts greater than the corresponding threshold element counts are identified.

Similarly, in step 88, any data points in the series of radiation signal data with total counts comparable to the threshold total counts and at least one of the element counts greater than the corresponding threshold element counts are identified.

Once these data points have been identified in steps 86 and 88, the identified data points are flagged as “low priority” points in step 90.

In step 92, the location data associated with each flagged data point is used to map the geographic coordinates of any data points which were flagged as “high priority” in step 84, using a first marker, and any data points which were flagged as “low priority” in step 90, using a second marker.

In an embodiment where there are more than one series of radiation signal data, the above steps are repeated for each series of radiation signal data until all of the series have been processed as indicated in step 94.

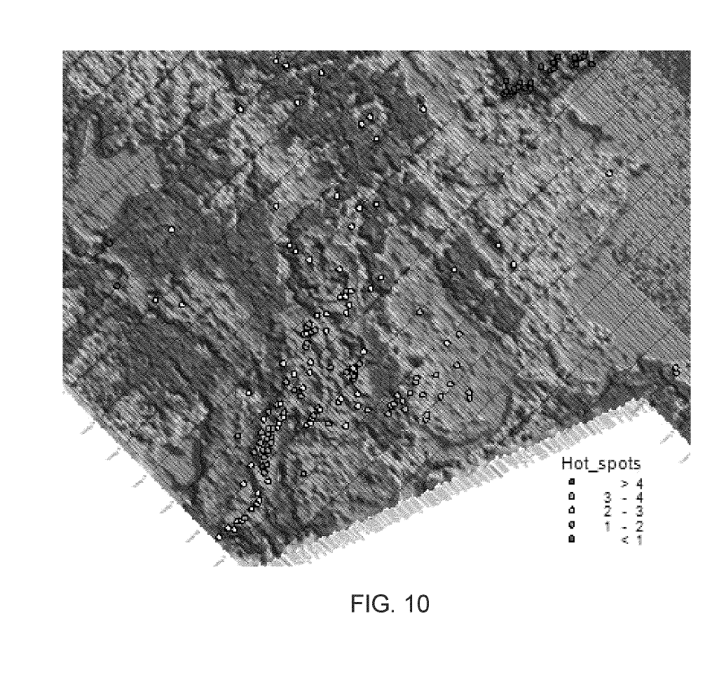

An example of a map produced using the above method is shown in FIG. 10. In this figure, the data points which were flagged as being “high priority” correspond to points which are mapped as “<1”, and the data points which were flagged as being “low priority” correspond to points which are mapped as “1-2”, “2-3”, “3-4” and “>4”. In one embodiment, only the “high priority” points are mapped to indicate the geographic coordinates of high interest. However, in a preferred embodiment, both the “high priority” points and the “low priority” points are marked on the same map using different markers, thus enabling the surveyor to observe a trend in the locations of the radioactive geological deposits and therefore assisting in the identification of coordinates with highly concentrated number of deposits. Based on this information, ground surveys may then be conducted to locate the radioactive deposits. In one aspect of the invention, the hotspot information is generally laid over the total counts, but can also be laid over ternary maps (with the color of a pixel being based on assigning each radioelement one part of the RGB color table). In another aspect, data can be mapped over various other data, such as, for example, a map indicating the direction of glacial ice flows, sedimentation type and thickness, etc.

FIG. 10 also illustrates the effect of large volumes of low concentration radioactivity masking the boulders, shown as contours. If these data were acquired by flying the aircraft at a higher altitude or if data was collected at a lower rate, many of the boulders may not be identifiable due to the high variability in the background noise.

As previously described, the surveys are conducted by carrying radiation detectors on an aircraft. In one embodiment, the aircraft is a helicopter; however, in a preferred embodiment, the aircraft is a fixed-wing airplane.

In an aspect of the invention, the aircraft may further include at least one or more of a lead collimator, a gamma telescope made with Compton shields, as well as additional sensors such as a GPS, an optically pumped magnetometer, barometer, thermometer and a laser altimeter. In a preferred embodiment, data obtained from the one or more additional sensors are used to interpret the radiation data.

Although the invention has been described with reference to certain specific embodiments, various modifications thereof will be apparent to those skilled in the art. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

1. A method for aerially surveying a geographic area for subterranean radioactive geological deposits using an aircraft having a plurality of gamma radiation detector elements, the plurality of gamma radiation detector elements being arranged in an array and comprising at least one center detector element and a plurality of outer detector elements, the plurality of outer detector elements surrounding the at least one center detector element and operable to block at least some incoming radiation from being detected by the at least one center detector element, the method comprising:
flying the aircraft over the geographic area to be surveyed at a ground speed of between 30 and 60 m/s and at a flight height of between 10 and 20 m above ground level; and,
acquiring a series of gamma radiation signal data using the plurality of gamma radiation detector elements.

2. The method of claim 1, further comprising storing and/or processing the series of acquired gamma radiation signal data.

3. The method according to claim 1, wherein the ground speed of the aircraft is between 45 and 55 m/s.

4. The method according to claim 1, wherein the flight height of the aircraft is between 10 and 15 m above ground level.

5. The method according to claim 1, wherein the series of gamma radiation signal data is acquired from the plurality of gamma radiation detector elements at a sampling rate of 80 MHz.

6. The method according to claim 1, wherein the plurality of outer detector elements is operable to block incoming radiation travelling towards the plurality of gamma radiation detector elements at sharp angles from being detected by the at least one center detector element.

7. The method according to claim 1, wherein sixteen radiation detector elements are used, and wherein the detectors are arranged in a 4×4 array.

8. The method according to claim 1, wherein the aircraft further includes at least one magnetometer or altimeter.

9. The method according to claim 1, wherein the series of gamma radiation signal data is processed and mapped by:
a) identifying data points in the series of gamma radiation signal data with total counts greater than a threshold total counts, and with at least one of the element counts greater than a corresponding threshold element count;
b) flagging the data points identified in step a) as “high priority” points;
c) identifying data points in the series of gamma radiation signal data with total counts greater than the threshold total counts, and with none of the element counts greater than the corresponding threshold element counts;
d) identifying data points in the series of gamma radiation signal data with total counts less than or equal to the threshold total counts, and with at least one of the element counts greater than the corresponding threshold element counts;
e) flagging any data points identified in steps c) or d) as “low priority” points; and,
f) mapping geographical coordinates corresponding to the “high priority” data points using a first marker and mapping geographical coordinates corresponding to the “low priority” data points using a second marker.

10. The method according to claim 9, wherein the threshold total counts is the background total counts and the threshold element count is the background element counts for each element.

11. The method according to claim 9, wherein the threshold total counts is one standard deviation above the background total counts and the threshold element counts is one standard deviation above the background element counts for each element.

12. The method according to claim 9, further comprising post-processing the series of gamma radiation signal data prior to the step of identifying any data points to be flagged.

13. The method according to claim 9, further comprising calibrating the series of gamma radiation signal data prior to the step of identifying any data points to be flagged.

14. A method for processing and mapping a series of radiation signal data acquired by aerially surveying a geographic area for any surface or subterranean radioactive geological deposits using an aircraft having at least one radiation detector element, the method comprising:
a) identifying data points in the series of radiation signal data with total counts greater than a threshold total counts, and with at least one of the element counts greater than a corresponding threshold element count;
b) flagging the data points identified in step a) as “high priority” points;
c) identifying data points in the series of radiation signal data with total counts greater than the threshold total counts, and with none of the element counts greater than the corresponding threshold element counts;
d) identifying data points in the series of radiation signal data with total counts less than or equal to the threshold total counts, and with at least one of the element counts greater than the corresponding threshold element counts;
e) flagging any data points identified in steps c) or d) as “low priority” points; and,
f) mapping geographical coordinates corresponding to the “high priority” data points using a first marker and mapping geographical coordinates corresponding to the “low priority” data points using a second marker.

15. The method according to claim 14, wherein the threshold total counts is the background total counts and the threshold element count is the background element counts for each element.

16. The method according to claim 14, wherein the threshold total counts is one standard deviation above the background total counts and the threshold element counts is one standard deviation above the background element counts for each element.

17. The method according to claim 14, further comprising post-processing the series of radiation signal data prior to the step of identifying any data points to be flagged.

18. The method according to claim 14, further comprising calibrating the series of radiation signal data prior to the step of identifying any data points to be flagged.

19. A system for conducting the method according to claim 1.

20. A system for aerially surveying a geographic area for surface or subterranean radioactive geological deposits, the system comprising:
an aircraft adapted to fly over the geographic area to be surveyed at a ground speed of between 30 and 60 m/s and at a flight height of between 10 and 20 m above ground level; and,
a plurality of gamma radiation detector elements adapted to acquire a series of gamma radiation signal data, the plurality of gamma radiation detector elements being arranged in an array and comprising at least one center detector element and a plurality of outer detector elements, the plurality of outer detector elements surrounding the at least one center detector element and operable to block at least some incoming radiation from being detected by the at least one center detector element.

21. The system of claim 20, wherein the plurality of outer detector elements is operable to block incoming radiation travelling towards the plurality of gamma radiation detector elements at sharp angles from being detected by the at least one center detector element.

22. The system of claim 20, wherein the plurality of gamma detector elements comprises sixteen radiation detectors and wherein the radiation detectors are arranged in a 4x4 array.

23. The system according to claim 20, further comprising at least one processor and at least one tangible computer readable storage medium having stored thereon a data processing module for:
a) identifying data points in the series of gamma radiation signal data with total counts greater than a threshold total counts, and with at least one of the element counts greater than a corresponding threshold element count;
b) flagging the data points identified in step a) as “high priority” points;
c) identifying data points in the series of gamma radiation signal data with total counts greater than the threshold total counts, and with none of the element counts greater than the corresponding threshold element counts;
d) identifying data points in the series of gamma radiation signal data with total counts less than or equal to the threshold total counts, and with at least one of the element counts greater than the corresponding threshold element counts;
e) flagging any data points identified in steps c) or d) as “low priority” points; and,
f) mapping geographical coordinates corresponding to the “high priority” data points using a first marker and mapping geographical coordinates corresponding to the “low priority” data points using a second marker.

24. The system according to claim 20, further comprising one or more tangible computer readable storage media having stored thereon a database for storing the series of gamma radiation signal data.
